(19) United States
(12) Patent Application Publication
(10) Pub. No.: US 2021/0163771 A1
(43) Pub. Date: Jun. 3, 2021

(54) METHOD FOR PRODUCING NANOPARTICLES, NANOPARTICLES, SYSTEM FOR PRODUCING NANOPARTICLES, AND METHOD FOR PRODUCING NANOPARTICLE INK FORMULATION

(71) Applicant: SHOEI CHEMICAL INC., Shinjuku-ku, Tokyo (JP)

(72) Inventors: Patrick Haben, Eugene, OR (US); Paul Tyrell, Corvallis, OR (US); David M. Schut, Blue Springs, MO (US)

(21) Appl. No.: 17/048,544

(22) PCT Filed: Apr. 16, 2019
(86) PCT No.: PCT/JP2019/016351

§ 371 Date: Oct. 16, 2020

Related U.S. Application Data
(60) Provisional application No. 62/659,007, filed on Apr. 17, 2018.

(51) Int. Cl. C09D 11/50; C09D 11/037; C09D 11/033; C09K 11/02; C09K 11/88; C09K 11/08; B01J 14/00; B01J 19/18

(52) U.S. Cl. CPC C09D 11/50; C09D 11/037; C09D 11/033; C09K 11/025; B82Y 20/00; C09K 11/0883; B01J 14/00; B01J 19/18; C09K 11/883

(57) ABSTRACT

Examples are disclosed that relate to method for producing nanoparticles using a shear-flow reactor. One disclosed example provides a method for producing nanoparticles with ligands bound to the surface of the nanoparticles, which comprises a step of mixing and processing a first solution and a second solution in a shear-flow reactor, and the first solution contains a first solvent in which nanoparticles having a initial ligand bound to the surface of the nanoparticles are dissolved, the second solution contains a second solvent in which the second ligand dissolved, a ligand exchange reaction is carried out in the shear-flow reactor to form a solution of the nanoparticles in which the second ligand is bound to the surface of the nanoparticles.

### TECHNICAL FIELD

The present invention relates to method for producing nanoparticles, nanoparticles, system for producing nanoparticles, and method for producing nanoparticle ink formulation.

This application is an application claiming priority under U.S. Provisional Application No. 62/659,007 filed Apr. 17, 2018, and the content of the US Provisional Application is incorporated herein by reference.

### BACKGROUND ART

A quantum dot is a semiconductor crystallite small enough to show evidence of ‘quantum confinement’. In this size regime, excitons generated within a crystallite are confined spatially by the crystallite's small dimensions. Various optical properties of a quantum dot are size-dependent, thus being tunable provided that quantum dots having desired sizes can be isolated. This property may be exploited in technologies leveraging the emissive properties of quantum dots including color displays, lighting, laser emission, etc., as well as technologies leveraging absorptive properties including photon detection, photovoltaic applications, etc. Its variability also may be exploited to make specialized electrooptical materials and/or electrooptical components, such as light-emitting diodes and down-shifting color-conversion sheets.

### CITATION LIST

### Patent Literature

Patent Literature 1: International Patent Publication No. WO2009/014588

Patent Literature 2: International Patent Publication No. WO2017/215093

Patent Literature 3: International Patent Publication No. WO2018/084262

Patent Literature 4: U.S. Patent Application Publication No. 2004/241430

Patent Literature 5: U.S. Patent Publication No. 7138355

### SUMMARY OF INVENTION

### Technical Problem

Nanoparticles such as quantum dots (hereinafter, also referred to as “_{Q}Ds”) and metal particles may be synthesized with an initial ligand bound to a surface of the nanoparticles. In such examples, the initial ligand may be chosen based on convenient chemical properties of the ligand for the synthesis of the nanoparticles. However, the chemical properties desired during synthesis may not be the same as the chemical properties desired for an application in which the nanoparticles will be placed or compatibility requirements of an end user of the nanoparticles. These properties may be adjusted using ligand exchange reactions to change the surface functionality of the nanoparticles to include a ligand that will provide the desired compatibility requirements, such as solubility within a given solvent or homogeneous dispersion within a given matrix. Ligand exchange may change the physical interactions of the nanoparticles in such a manner as to produce a material that is compatible with a given matrix, product or solvent system. Patent Literatures 1 (PTL 1) and Patent Literature 2 (PTL 2) disclose ligand exchange.

Details of the ligand exchange will be explained taking QDs as an example. Ligand exchange reactions may include removal of an existing ligand shell (a layer comprising a plurality of ligands coating a surface of the QD), and replacement of the existing ligand shell with new ligands that match the desired chemical properties, such as solubility. Thus, an example ligand exchange reaction may be described by the following equilibrium equation:

QD−(Lᵢₙᵢₜᵢₐₗ)ₙ↔QD−(Lᵢₙᵢₜᵢₐₗ)ₙ₋₁↔QD−(Lᵢₙᵢₜᵢₐₗ)ₙ₋₁(L_{secondary})₁

In the equation shown above, QD−(Lᵢₙᵢₜᵢₐₗ)ₙ represents a quantum dot (QD) bound to n initial ligand(s) that may comprise an initial ligand shell surrounding the QD. As described above, the initial ligand may be chosen for synthetic convenience. For example, the initial ligand may be chosen to induce solubility of QD precursors in the solvent in which they are synthesized, as well as to provide stability towards aggregation and towards agglomeration. Aggregation may occur when solvent-ligand interactions are much weaker than ligand-ligand interactions of ligands attached to the surface of the QD.

With reference again to the equation shown above, one initial ligand may dissociate from the surface of the QD in the equilibrium process indicated by the first double-sided arrow from the left of the equation. This complex is represented by QD−(Lᵢₙᵢₜᵢₐₗ)ₙ₋₁. A second ligand (L_{secondary}) may associate with QD−(Lᵢₙᵢₜᵢₐₗ)ₙ₋₁ to form QD−(Lᵢₙᵢₜᵢₐₗ)ₙ₋₁(L_{secondary})₁.

The second ligand, as described above, may be the ligand to be used in the final product and may provide the desired compatibility requirements, such as solubility within a given solvent or homogeneous dispersion within a given matrix. For example, aqueous QD solutions may be useful in jetting and/or ink applications.

As the desired effects of ligand exchange may include dramatically altering the solubility of the QD, a desired surface functionality of the QD may utilize a second ligand that is not soluble in a solution of QD−(Lᵢₙᵢₜᵢₐₗ)ₙ. Thus, it may be optimal to perform ligand exchange via a biphasic process.

Biphasic ligand exchange reactions may be challenging, as the initial solvent and ligand choices may have to facilitate ligand diffusion between disparate phases. This may result in the associative part of the reaction shown above occurring slowly. In some examples, ligand exchange reactions may take greater than 48 hours to exchange even a small number of ligands. Concentrations may be carefully controlled, and a phase transfer catalyst may be utilized to increase the rate of molecular transfer across phase boundaries. However, sub-optimal conditions may result in QD aggregation or simply no reaction at all. Successful results may come from careful trial-and-error experimentation yet may still result in a time-intensive process that may take days to complete.

Additionally, ligand exchange reactions may be carried out in batch processes in which the QD bound to the initial ligand is placed in solution with a large, excess amount of the second ligand. In some examples, the second ligand may be placed in large excess due to Le Chatelier's principle: because an equilibrium is formed, the large excess of the second ligand may move the equilibrium to the right-hand side of the equation illustrated above.

In some examples, the binding strength of the quantum dot to the initial ligand (QD-L) is greater than the binding strength of the quantum dot to the second ligand (QD-L_{secondary}). In this case, heating or other energy input may be applied to accelerate dissociation of the initial ligand. However, such ligand exchange reactions may be slow and may not result in complete conversion of the QD bound to the initial ligand to the QD bound to the second ligand. In other examples, when the QD-L_{secondary} bond strength is greater than the QD-Lᵢₙᵢₜᵢₐₗ bond strength, the reaction may proceed rapidly and almost 100% ligand exchange may occur.

In one example, the initial ligand is a ligand having a thiol group. Specific examples of the ligand having a thiol group are not particularly limited, and examples thereof include alkylthiols such as 1-dodecanethiol (1-DDT). When the initial ligand is 1-DDT, the dissociation may take a large amount of energy due to the strong (QD)-(1-DDT) bond. Additionally, dissociation proceeds slowly and results in an equilibrium that does not come close to 100% ligand exchange.

When using ligands with strong binding force such as in the case of 1-DDT, ligand exchange may occur very slowly, and large amounts of excess secondary ligand in solution may be used in order for even a small number of QDs to have their surface changed enough to be utilized in a new solvent or matrix. Generating microemulsions in biphasic mixtures may greatly reduce the time to conduct biphasic ligand exchange. For example, sonication along with vigorous mixing may be utilized to generate microemulsions, which greatly increases an interfacial area between phases and introduces more energy into the system. In the case of biphasic mixtures, a phase transfer catalyst may also be used in conjunction with vigorous mixing and sonication to help promote exchange. However, this technique may still take up to 24 hours to complete the ligand exchange reaction.

Therefore, an object of the present invention is to provide a method for producing nanoparticles, a system for producing nanoparticles, and a method for producing nanoparticle ink formulation, which can carry out a ligand exchange reaction in a short time when producing nanoparticles having a desired ligand on the surface of the nanoparticles.

### Solution to Problem

A method for producing nanoparticles with ligands bound to the surface of the nanoparticles, which comprises a step of mixing and processing a first solution and a second solution in a shear-flow reactor, and the first solution contains a first solvent in which nanoparticles having a initial ligand bound to the surface of the nanoparticles are dissolved, the second solution contains a second solvent in which the second ligand dissolved, a ligand exchange reaction is carried out in the shear-flow reactor to form a solution of the nanoparticles in which the second ligand is bound to the surface of the nanoparticles.

A shear-flow reactor, such as a spinning disc reactor, may include one or more rotating discs spaced on the order of 10-100 μm from another surface, such as a counter-rotating disc. The one or more rotating discs apply mechanical shear force in a highly-localized manner, which may enable the intimate mixing of solutions.

A system for producing nanoparticles with ligands bound to the surface of the nanoparticles, which comprises a first input system, a second input system, a rotator, a stator and a collect system, and the first input system configured to input a first solution, the first solution comprising the nanoparticle bound to an initial ligand and dissolved in a first solvent;

the second input system configured to input a second solution, the second solution comprising a second ligand dissolved in a second solvent;

the rotor and the stator are configured to process a mixture of the first solution and the second solution to carry out a ligand exchange reaction on the nanoparticles;

the collect system configured to output a product mixture comprising the nanoparticles bound to the second ligand and dissolved in the second solvent.

A method for producing nanoparticles, the method comprising:

combining, in a shear-flow reactor, a first input and a second input, the first input comprising a solution of a group III element precursor compound dissolved in a solvent, and the second input comprising a gaseous phosphorus precursor compound; and

processing the first input and the second input in the shear-flow reactor to form a solution of the nanoparticle.

A method for producing nanoparticle ink formulations, the method comprising:

combining, in a shear-flow reactor, a first solution and a second solution, the first solution comprising a nanoparticle in a first solvent, and the second solution comprising a second ink component dissolved in a second solvent; and

processing the first solution and the second solution in the shear-flow reactor to form a product mixture comprising a mixed nanoparticle ink.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### Advantageous Effects of Invention

The present invention provides a method for producing nanoparticles, a system for producing nanoparticles, and a method for producing nanoparticle ink formulation, which can carry out a ligand exchange reaction in a short time when producing nanoparticles having a desired ligand on the surface of the nanoparticles.

### BRIEF DESCRIPTION OF DRAWINGS

FIG. 1 is a diagram illustrating an outline of an example of a shear-flow reactor used in the method for producing nanoparticles according to the embodiment of the present invention.

FIG. 2 shows a plot showing the normalized absorbance of quantum dots that are the product of a ligand exchange reaction by a batch or shear-flow process.

FIG. 3 is a diagram illustrating an outline of an example of a continuous flow reactor used in the method for producing nanoparticles according to the embodiment of the present invention.

FIG. 4 is a flow chart showing an example of a method for producing nanoparticles according to the embodiment of the present invention.

FIG. 5 is a diagram showing an outline of an example of ligand exchange using the system for producing nanoparticles according to the embodiment of the present invention.

FIG. 6 is a flow chart showing an exemplary method for synthesizing quantum dots by the method for producing nanoparticles according to the embodiment of the present invention.

FIG. 7 is a diagram showing an outline of an example of quantum dot synthesis according to the embodiment of the present invention.

FIG. 8 is a flow chart showing an example of a method for producing a nanoparticle ink formulation according to the embodiment of the present invention.

FIG. 9 is a diagram of an example of a method for producing nanoparticle ink formulation using a system for producing nanoparticle ink formulation according to the embodiment of the present invention.

FIG. 10 is a diagram showing an outline of an example of a quantum dot and a ligand coordinated to the quantum dot according to the embodiment of the present invention.

FIG. 11A is a diagram showing the proportion of various ligands coordinated to the quantum dots before the ligand exchange, and of ligands coordinated to the quantum dots prepared in Comparative Example 1 and Example 1, respectively.

FIG. 11B is a diagram showing the proportion of the various ligands coordinated to the quantum dots before the ligand exchange, and of ligands coordinated to the quantum dots prepared in Comparative Example 2 and Example 2, respectively.

### DESCRIPTION OF EMBODIMENTS

The method for producing nanoparticles according to the embodiment of the present invention is a method in which nanoparticles having a ligand bonded to the surface of the nanoparticles are treated with a shear-flow reactor to carry out a ligand exchange reaction. The nanoparticles may be quantum dots or metal particles. A shear-flow reactor, such as a spinning disc reactor, may combine multiple flowing streams together between closely spaced surfaces, on the order of 10-100 μm apart in some examples, having differential rotational movement. The opposing surfaces may comprise a rotor and a stator in some reactors, or counter-rotating discs in others. The relative motion of these surfaces applies mechanical shear force in a high-localized manner. The resulting highly-localized shear forces enable the intimate mixing of the streams, including biphasic solutions, and provide sufficient energy to allow for the dissociation of ligands from the surface of the nanoparticles. This may facilitate the removal of bound ligands in monophasic systems and may help to greatly increase the rate of ligand exchange.

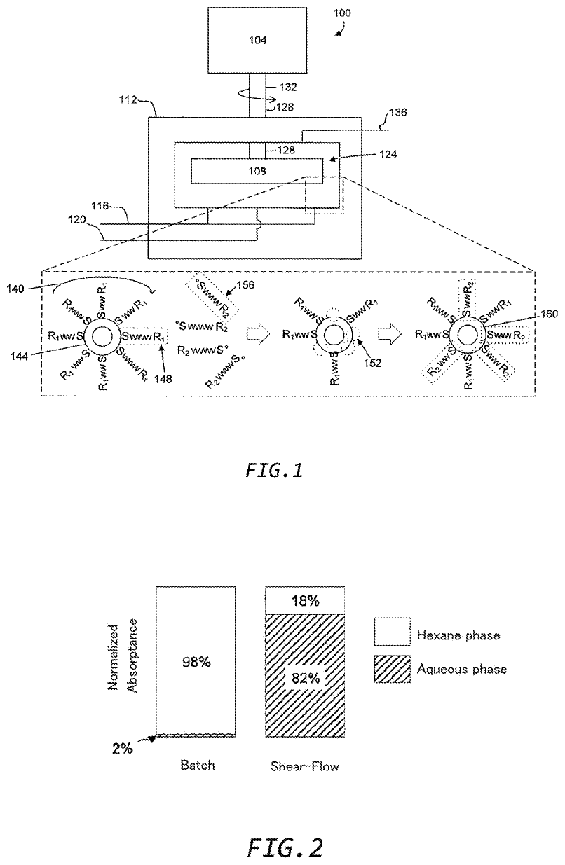

FIG. 1 shows a schematic depiction of an example shear-flow reactor 100 that may be used for conducting ligand exchange reactions on a quantum dot. In the example of FIG. 1, the shear-flow reactor 100 includes a motor 104, a rotor 108 and a stator 112. The rotor and the stator may be spaced very closely together, on the order of tens to hundreds of microns apart.

At least two flowing streams, input by first input system 116 and second input system 120, may enter a space 124 between the rotor 108 and the stator 112 via a pump or other suitable mechanism, and mix. As described in more detail below, the first input system 116 may be configured to input a first solution comprising a quantum dot bound to an initial ligand and dissolved in a first solvent, and the second input system 120 may be configured to input a second solution comprising a second ligand dissolved in a second solvent, which may be miscible or immiscible in the first solvent.

The rotor 108 is coupled to the motor 104 by a coupling 128 (e.g. a shaft) to allow the motor 104 to cause the rotor 108 to rotate at high speed, applying mechanical shear force in a highly localized manner. The resulting mixture, which may comprise a final product mixture or an intermediate mixture, may be collected via a collect system 136.

Applying highly localized force in this manner enables the intimate mixing of phases, dispersion of solids, and breakdown of agglomerates. For example, the incorporation of nano-scale particles into a liquid may be challenging due to the presence of strong attractive interparticle forces. The difficulty of incorporation may vary from one application to another as dictated by factors such as particle size and shape, fluid type, and presence of a dispersing agent. Not all nanoparticles may require extreme shear for deagglomeration. However, when conventional rotor/stator mixers and milling equipment fail to achieve a desired level of dispersion, shifting to a higher intensity device may be recommended. A measured size distribution of nanoparticles may be narrowed by breaking up agglomerates in this manner.

Highly-localized shear forces applied to reduce agglomerate sizes may also add kinetic energy, resulting in increased molecular mobility and increased available surface sites for chemical attachment. This mechanism may promote exchange of ligands as well as attachment of dispersing agents, such as surfactants. The highly localized shear forces may also facilitate the removal of bound ligands in monophasic systems by a molecular-scale effect on the nanoparticle ligand shells, causing local mechanical stress, thereby rotating QDs and mechanically removing or stripping off ligands.

For example, FIG. 1 schematically illustrates shear force (via arrow 140) inducing mechanical stress on a core-shell quantum dot 144 bound to an initial ligand 148. In the illustrated example, the initial ligand 148 is a ligand having a thiol group (hereinafter referred to as a thiol ligand), and is bound to a surface of the quantum dot 144 via a sulfur atom of the thiol ligand. The shear force 140 may facilitate dissociation of the initial ligand 148, resulting in one or more empty coordination sites 152 on the surface of the quantum dot 144. A second ligand 156 may then bind to the surface of the quantum dot 144 at the one or more empty coordination sites 152. In the illustrated example, the second ligand 156 is also a thiol ligand, and differs from the initial ligand 148 in that the second ligand 156 possesses functional group R₂ in place of functional group R₁ on the initial ligand 148. The second ligand 156 is also depicted in FIG. 1 associating with the quantum dot 144 in the same manner as the initial ligand 148. However, it will be appreciated that any other suitable ligand and method of associating with the quantum dot 144 may also be used.

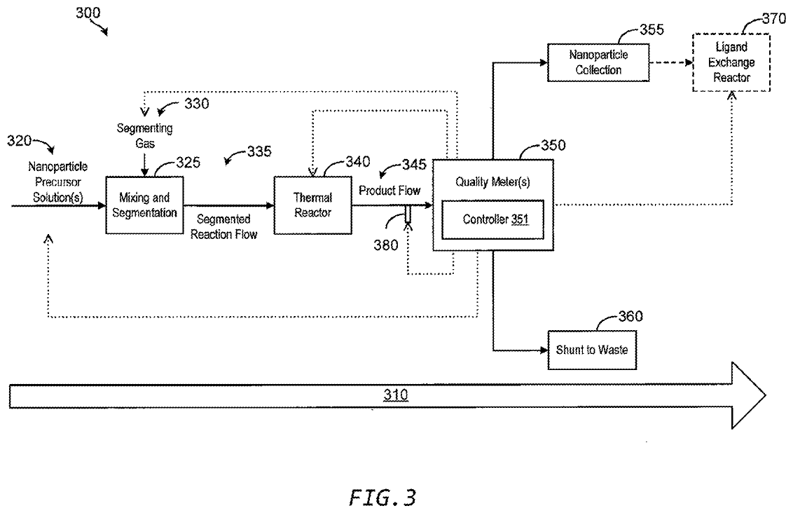

In this manner, and as illustrated in FIG. 1, shear forces provided by a shear-flow reactor may greatly increase a rate of ligand exchange. For example, traditional batch processes may take 24 to 48 hours or more to enable ligand exchange, while in a method using a shear-flow reactor may allow ligand exchange to occur in 1-2 minutes. Further, in some examples, an increase in extent of ligand exchange over traditional batch processes may be observed. High-throughput ligand exchange may be further achieved by leveraging additional capabilities of the shear-flow reactor 100. For example, shear-flow reactor 100 may be implemented in an in-line flow cell reactor system, discussed in more detail below with respect to FIG. 3.

Integration with in-line flow geometries may help achieve scalability in quantum dot ligand exchange. An increase in throughput may also be achieved using multi-stage spinning disc reactors, which may have multiple spinning discs and larger total fill volumes than single-stage spinning disc reactors. In addition, engineering parameters such as rotor-stator distance, flow rate, and rotor spin rate may be adjusted to target specific ligand exchange syntheses and particle sizes.

In some examples, a first solution of purified ligand-bound QDs, such as InP, may be suspended in a nonpolar organic phase, such as 1-octadecene, toluene, hexane, or other suitable solvent, and a second solution of a second ligand may be provided in either a nonpolar phase (e.g. the same nonpolar phase) or a polar phase (e.g. water, PGMEA (propylene glycol methyl ether acetate), or ethanol). As such, the second solution may be miscible or immiscible in the first solution.

These solutions may be pumped into the shear-flow reactor and combined under the shear-flow conditions to provide intimate mixing via the localized shear forces. The shear-flow reactor also may allow the phases to be mixed at elevated temperatures and pressures: temperature may be elevated due to the input of shear mechanical force into the solutions in the shear-flow reactor, and pressure may be increased as a result of several flows entering the same thickness of tubing or flow going into a restricted space, such as between the one or more discs. Temperature and pressure may also be controllable in some systems for producing nanoparticle using the shear-flow reactor.

In some examples, a product stream from the shear-flow reactor (e.g. as collected via collect system 136) may be directed through additional post-exchange processes. For example, the product stream may be directed through an oven to employ further heating. In the system for producing nanoparticles, if the characteristics of the product stream are not found to be within the predetermined specifications by analysis of the product stream, the product stream may be sent to the shear-flow reactor again, and these may be performed continuously. When the product stream is sent to the shear-flow reactor again, the temperature, pressure, processing time, etc. may be adjusted as appropriate.

In some examples, the product of such ligand exchange reactions may comprise a quantum dot dissolved in an aqueous solution, such as quantum dot 160 of FIG. 1. The quantum dot 160 may have a ligand, such as second ligand 156, soluble in the aqueous solution bound to a surface of the quantum dot 160. It will be understood that some concentration of initial ligand 148 may remain on the quantum dot surface after the ligand exchange process.

FIG. 2 depicts the normalized absorptance of quantum dots after separating products of two different ligand-exchange techniques. The “batch” column of FIG. 2 illustrates the results, in terms of normalized absorptance, of a traditional batch process. The “shear-flow” column illustrates the results of a ligand-exchange process utilizing a shear-flow reactor. As illustrated in FIG. 2, in the traditional batch process, the aqueous phase had 2% normalized absorptance, compared to 98% in the hexane phase. In contrast, the shear-flow reactor process resulted in an aqueous phase with 82% normalized absorptance, and 18% in the hexane phase.

As described above, a system for producing nanoparticles for conducting ligand exchange reactions on a quantum dot may be integrated into an in-line continuous flow reactor. FIG. 3 schematically shows an example continuous flow reactor 300 for synthesizing nanoparticles. Continuous flow reactor 300 comprises continuous flow path 310. Continuous flow path 310 may comprise one or more flow tubes. The one or more flow tubes may include flow tubes running in parallel. The flow tubes may, at certain points in continuous flow path 310, merge or diverge. Each flow tube may have any suitable diameter. In some examples, each flow tube may comprise an inner diameter between 1/16″ to 1″ inch. Flow rates of material through the continuous flow path may be regulated by one or more pumps, such as a peristaltic pump, or any other suitable methods or devices.

The shear-flow reactor described in the present application can be used for producing nanoparticles. Patent Literature 3 (PTL 3) and Patent Literature 4 (PTL 4) disclose conventional methods for producing nanoparticles.

In FIG. 3, at 320, one or more nanoparticle precursor solutions are shown being introduced into continuous flow path 310. The nanoparticle precursor solutions may include one or more metal salts, such as a metal acetate, metal halide, or other salt that may be dissolved in an appropriate solvent, such as a nonpolar solvent (e.g. octadecene), for the continuous flow reaction. The nanoparticle precursor solutions further may include one or more anion sources. The nanoparticle precursor solutions may further include one or more initial ligands bound to the precursors, thus increasing their solubility in the solvent. In some examples, where the resultant nanoparticle is a multi-metal nanoparticle, two or more nanoparticle precursor solutions may be mixed together in an appropriate stoichiometric ratio to form a mixed precursor reaction solution.

Once prepared and introduced into continuous flow path 310, the nanoparticle precursor solutions may flow to a mixing and segmentation stage 325, which mixes the solutions into a substantially homogeneous mixed reaction flow and then introduces a segmenting fluid, at 330, to the mixed reaction flow to segment the precursor reaction flow into a segmented reaction flow 335. Any suitable segmenting fluid may be used, such as a gas or liquid that is substantially immiscible in the precursor reaction solution solvent and inert to reaction with the solvent. In this way, the continuous flow reaction is segmented into a plurality of micro-reactions (reactions occurring in segmented portions of the continuous flow). The segmentation allows for controlled flow of the reagents through the continuous flow reactor. Segment size and reaction flow rate may be indicated by a controller. The segmentation increases mixing within each micro-reaction. With an unsegmented reaction flow, material along the tube wall interface moves more slowly through the flow tube than does material in the center of the tube, and thus some material will spend a longer duration in the continuous flow reaction than other material. With segmented flow, the flow rate becomes more homogeneous for the reagents. Further, the micro-reaction is continuously mixed due to the drag incurred at the tube wall interface. As shown in FIG. 3, the segmenting gas is introduced to the mixed reaction flow at mixing and segmentation stage 325. In other examples, the segmenting gas may be introduced at a different location upstream of the thermal reactor. The flow rate of segmenting gas introduced into the mixed reaction flow may be adjusted to increase or decrease the volumes of the micro-reactions within the segmented reaction flow.

In some examples, the pressure within continuous flow path 310 may be increased or decreased. For example, increasing the pressure in the flow path may increase the boiling point of the reaction solvent, thereby allowing the system to operate at higher temperatures and energy levels. In one example, the flow path pressure may be increased by inserting a restrictive flow valve 380 into the flow path downstream of the thermal reactor. The flow through valve 380 may be adjusted to increase the pressure in the flow path upstream of the valve, thereby increasing the pressure in the flow path through the thermal reactor.

At 340, the segmented reaction flow is transported to a thermal reactor. To stimulate the assembly of nanoparticles from the nanoparticle precursors, heat may be introduced to the continuous flow reaction. This may include passing the segmented reaction flow through one or more thermal reactors (e.g., convection heater, near-IR heater, etc.).

The material resulting from thermal processing may be considered a product flow 345. The product flow exiting thermal reactor 340 then may be subject to metrology by one or more quality meters 350. Metrology may include measuring the optical and/or physical size properties of the product flow. For example, the product flow may be flowed through one or more in-line light absorbance spectrometers to determine optical properties, and one or more in-line light scattering spectrometers to determine physical size properties. If the measured properties of the product flow are within a predetermined range of specifications, continuous flow reactor 300 may divert the product flow to 355, where the nanoparticle products may be collected.

If the measured properties of the product flow are not within the predetermined range of specifications, controller 351 of continuous flow reactor 300 may shunt the product flow to waste at 360. Further, based on the measured properties of the product flow, controller 351 may adjust one or more parameters of continuous flow reactor 300, such as flow rates, precursor solution stoichiometry, segment size, and processing temperature may be adjusted. As the flow reaction is continuous may be at a high flow rate, and the metrology is done in-line, the effects of the parameter adjustments may be gauged and iterated to fine-tune the reaction conditions without wasting an excess of material. In other examples, samples may be removed from the flow for analysis, rather than analyzed in-line.

Nanoparticle products that meet the prescribed specifications may be collected by removing the segmenting gas and precipitating the nanoparticle products in an organic solvent. The nanoparticle products may be purified (e.g. by cycles of precipitation and dissolution and/or filtration) and collected. The nanoparticle products may be re-dissolved in an appropriate solvent for downstream applications.

Continuous flow reactor 300 then may direct the collected nanoparticle products to a ligand exchange reactor 370. For example, the nanoparticles may be synthesized in a nonpolar solvent in the presence of a lipophilic ligand, but the desired product may be a nanoparticle soluble in water. As such, the nanoparticle products may be collected by removing the segmenting gas, and then transported to ligand exchange reactor 370. An aqueous solution comprising a hydrophilic ligand may concurrently be flowed to ligand exchange reactor 370. At the ligand exchange reactor, an emulsion may be formed of the nanoparticle product in the nonpolar solvent and the aqueous solution. This may thus promote exchange of the first, lipophilic ligand for the second, hydrophilic ligand on the surface of the nanoparticles. An aqueous fraction may then be collected from ligand exchange reactor 370, comprising nanoparticles bound to hydrophilic ligand.

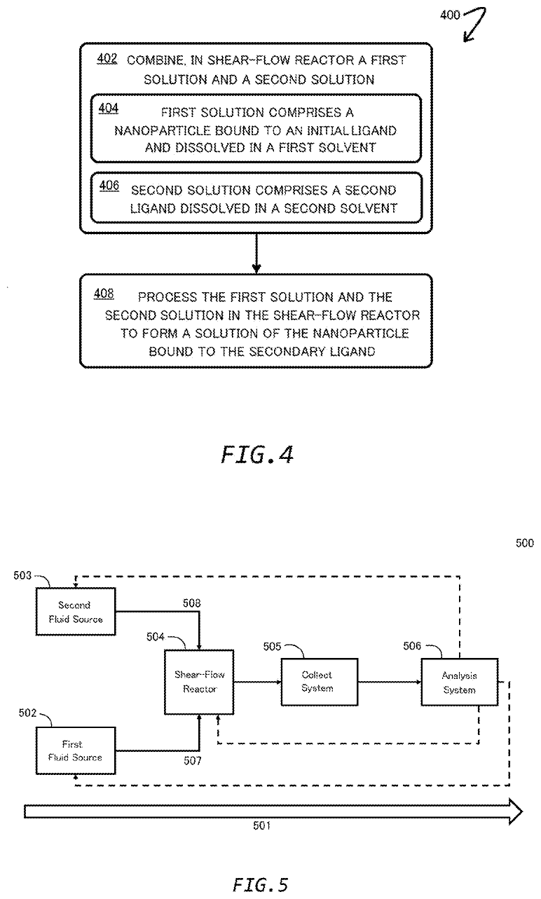

FIG. 4 illustrates a flow diagram depicting an example method 400 for conducting ligand exchange reactions on a nanoparticle. Method 400 comprises, at 402, combining, in a shear-flow reactor, a first solution and a second solution. The first solution comprises the nanoparticle bound to an initial ligand and dissolved in a first solvent, as indicated at 404, and the second solution comprises a second ligand dissolved in a second solvent, as indicated at 406. The second solvent may be immiscible or miscible in the first solvent. At 408, the method comprises processing the first solution and the second solution in the shear-flow reactor to form a solution of the nanoparticle bound to the second ligand.

FIG. 5 shows an example of ligand exchange using a system for producing nanoparticles. The quantum dot solution in which the initial ligand is coordinated is referred to as the first fluid source 502, and the solution of the second ligand is referred to as the second fluid source. The first fluid source and the second fluid source pass through the continuous flow path 501 and ligand exchange is conducted. The continuous flow path 501 may comprise one or more flow tubes.

The quantum dot solution in which the initial ligand is coordinated flows from the first fluid source 502 into the shear-flow reactor 504 via the first input system 507, and the second ligand solution flows from the second fluid source 503 into the shear-flow reactor 504 via the second input system 508. The quantum dot solution in which the ligand has been exchanged as described above in the shear-flow reactor is recovered by the collect system 505. The product stream collected by the collect system 505 is sent to the analysis system 506 for analysis. Here, the collect system and the analysis system do not need to be continuous. In the analysis system, if the ligand coordination of the obtained quantum dot solution is not within the predetermined specifications, the quantum dot solution can be sent to the shear-flow reactor again. At this time, the flow rate and concentration of the input source flowing from the input system may be changed, and also the temperature and pressure in the shear-flow reactor, the rotation speed of the rotor, and the distance between the rotor and the stator may be changed.

In another example, with reference again to FIG. 3, a shear-flow reactor system may be used in place of or in conjunction with thermal reactor 340 for synthesizing quantum dots. To synthesize quantum dots, the first input system, such as input system 116 of FIG. 1, may be configured to input a first solution that may be the solution of one or more metal salts, such as a metal acetate, metal halide, or other salt described above with regard to FIG. 3. The first solution may, for example, be a group III element precursor compound dissolved in a solvent, such as a liquid solution of an indium precursor compound in a nonpolar solvent.

To produce InP quantum dots, for example, a second input system, such as input system 120 of FIG. 1, may input a gaseous phosphorus precursor compound. In this example, a gaseous phosphorus precursor compound may be provided via a mass flow controller in place of a pump. Phosphine (PH₃) is one example of a gaseous precursor compound, which may be an attractive source of phosphorous for InP quantum dots, as it is highly reactive and may not produce undesired side-products via ligand-dissociation. However, phosphine has a boiling point of −88° C., and forms a gas under standard conditions, which may make it difficult to mix with liquid indium precursors. The system for producing nanoparticles using shear-flow reactor may enable the intimate mixing of liquid and gas phases, similar to the mixing of biphasic liquid mixtures, even when using phosphine.

The shear-flow reactor illustrated by example in FIG. 1 comprises a space between the rotor and the stator where the first input stream and the second input stream are combined. The rotor may rotate at high speed to mix the group III element precursor and the phosphorus precursor into a product mixture or an intermediate mixture, which may comprise the quantum dot, such as an InP quantum dot. The product mixture may then be output from the space via a collect system, or the intermediate mixture may be directed into additional reactor stages, such as an oven or heating stage, of an in-line continuous flow reactor, such as the continuous flow reactor 300 of FIG. 3. In this manner, a shear-flow reactor for synthesizing quantum dots may facilitate the production of quantum dots via a variety of synthesis methods that may additionally result in new product formulations.

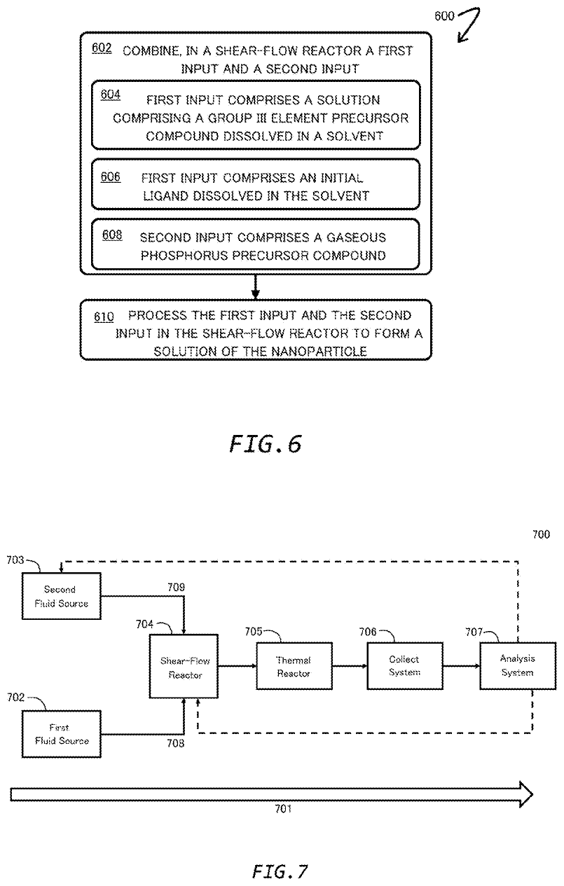

FIG. 6 illustrates a flow diagram depicting an example method 600 for synthesizing quantum dots. Method 600 comprises, at 602, combining, in a shear-flow reactor, a first input and a second input. The first input comprises a solution of a group III element precursor compound dissolved in a solvent, as indicated at 604. The first input may also comprise an initial ligand dissolved in the solvent, as indicated at 606. As indicated at 608, the second input comprises a gaseous phosphorus precursor compound. At 610, the method 600 comprises processing the first input and the second input in the shear-flow reactor to form a solution of the nanoparticle.

FIG. 7 shows an example of quantum dot synthesis using a quantum dot producing system.

The Group III element precursor solution is referred to as the first fluid source 702, and the gaseous phosphorus precursor compound is referred to as the second fluid source 703. The first fluid source and the second fluid source pass through the continuous flow path 701 to synthesize quantum dots. The continuous flow path 701 can include one or more flow tubes.

The Group III element precursor solution flows from the first fluid source 702 into the shear-flow reactor 704 via the first input system 708, and the gaseous phosphorus precursor compound flows from the second fluid source 703 into the shear-flow reactor 704 via the second input system 709. An intimate mixture of the liquid and gas phases takes place in the share-flow reactor and is then sent to the thermal reactor 705 where it is heated to produce quantum dots. The resulting product stream is collected by the collect system 706. The product stream collected by the collect system 706 is sent to the analysis system 707 for analysis. Here, the collect system and the analysis system do not need to be continuous. In the analysis system, if the properties of the resulting quantum dots are not within the predetermined specifications, the product stream can be sent again to the shear-flow reactor or the thermal reactor (not shown). As this time, the flow rate and concentration of the input source flowing from the input system may be changed, and also the temperature and pressure in the shear-flow reactor, the rotation speed of the rotor, and the distance between the rotor and the stator may be changed.

In another example, a shear-flow reactor may be used for producing nanoparticle ink formulations. In such an example, the first input system, such as input system 116 of FIG. 1, may be configured to input a first solution of a first ink component dissolved in a first solvent. Examples of the first ink component include nanoparticles (including ligands coordinated to the nanoparticles). A second input system, such as input system 120 of FIG. 1, may be configured to input a second solution of a second ink component dissolved in a second solvent, which may be miscible or immiscible in the first solvent. The second ink component includes, for example, an anti-drying agent, a penetrant agent, a pH adjuster, a chelating agent, a surfactant, an anti-bacterial agent, an anti-fungal agent, a dispersant, an anti-foaming agent, a coloring agent, and a moisturizing agent, and is appropriately selected from the above-mentioned components as necessary. Traditionally, ball mills or bead mills are used to mix ink components (see Patent Literature 5 (PTL 5)). A mixing technology using a ball mill, a bead mill, or the like is an established ink processing method. In one example of bead milling, ink components are placed in a mill having a cylindrical container with millimeter-scale beads. The container is rotated for long durations to apply mechanical force to the ink components to generate a homogenous mixture. In this system, mixing energy is kinetically transferred to sample components via contact with balls of various designs.

In the method for producing nanoparticle ink formulation, utilization of a continuous-flow-compatible spinning disc reactor or shear-flow reactor may help to achieve savings in processing time when compared to the case of using the conventional similar mixing method such as a ball-mill mixing system. In this example, the first input stream and the second input stream combine in the space between the rotor and the stator, and the rotor rotates to mix the first ink component and the second ink component into a product mixture comprising mixed ink.

In this example, localized shear forces provided by the shear-flow reactor impart mechanical energy on a much smaller scale than using a traditional bead mill to promote ink system mixing, which may reduce the time to generate homogenous inks and improve mixing homogeneity. One example may include the mixing of sample compounds such as ligands, and surface-active additives such as dispersants and surfactants. A shear-flow reactor may help to increase the degree of exchange and/or bonding of the sample components over that of conventional methods, and therefore increase a scope of sample materials that may be utilized.

The method for producing nanoparticle ink formulation using a shear-flow reactor can reduce process cycle time, thereby may lead to increased return on investment, as an increased number of disparate samples can be processed in a certain time. While traditional batch processing in a bead mill may take 24 hours per process cycle, the process cycle may be completed in a much shorter time, such as 10 seconds to 1 minute, using a shear-flow reactor, allowing for up comparatively more process cycles or process cycle equivalents to be run per day. Also, as the shear-flow reactor does not include milling balls, such a reactor may allow for reduced cleaning and/or replacement of components compared to a bead mill or ball mill reactor, reducing consumable component demands.

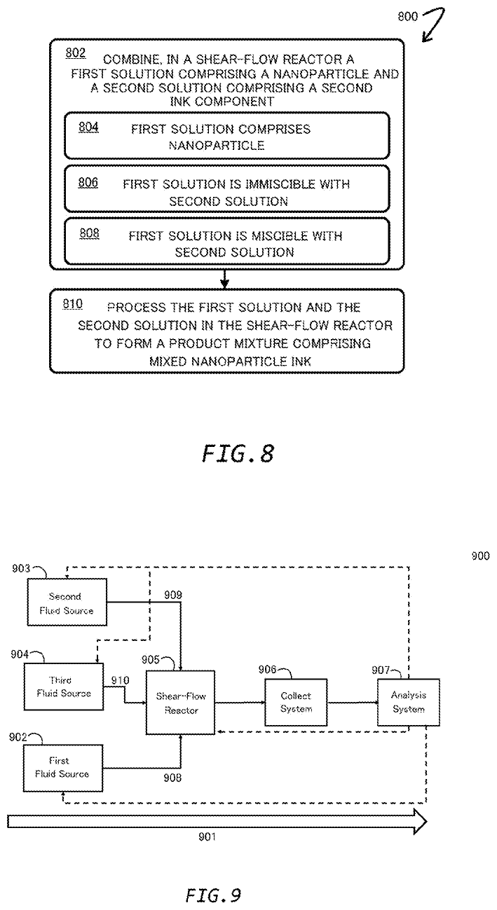

FIG. 8 illustrates a flow diagram depicting an example method 800 for producing nanoparticle ink formulations. At 802, method 800 comprises combining, in a shear-flow reactor, a first solution comprising a nanoparticle and a second solution. As indicated at 804, the first solution comprises a nanoparticle. The second solution includes, for example, an anti-drying agent, a penetrant agent, a pH adjuster, a chelating agent, a surfactant, an anti-bacterial agent, an anti-fungal agent, a dispersant, an anti-foaming agent, a coloring agent, and a moisturizing agent. In some examples, the first solution may be immiscible in the second solution, as shown at 806, while in other examples, the first solution may be miscible in the second solution, as shown at 808. At 810, method 800 includes processing the first solution and the second solution in the shear-flow reactor to form a product mixture comprising mixed nanoparticle ink mixture.

In some examples, a formulation of mixed nanoparticle ink may comprise a single phase. In such examples, a mono phase ink formulation may comprise 50-98% water by weight and 0.01-40% quantum dots or metal nanoparticles by weight. The metal nanoparticles may comprise metals such as Ni, Ag, Cu or Au. The mono phase nanoparticle ink formulation may also comprise 0.01-10% surfactants by weight. The surfactants may comprise one or more of ionic, non-ionic and zwitterionic materials.

In other examples, the formulation of mixed nanoparticle ink may comprise multiple, mixed phases. In some such examples, a mixed phase nanoparticle ink formulation may comprise 30-98% aqueous solvents by weight, 2-50% organic solvents by weight. In these examples, the mixed phase nanoparticle ink formulation may comprise 0.01-40% quantum dots or metal nanoparticles by weight. The mixed phase nanoparticle ink formulation may also comprise 0.01-10% surfactants by weight.

Method 800 may be implemented in a variety of manners. As one example, a simple two-component mixed phase batch reaction system may be established to produce quantum dot inks. In such a method, a first component may be prepared containing quantum dots in a supporting organic solvent, such as hexane or a mixture of hexanes. A second component may be prepared containing a dispersant agent in an aqueous solvent. The first component and the second component may be injected simultaneously into the shear flow reactor while the shear-flow reactor is running using predetermined functional parameters, as described above. Post-reacted material may then be collected, comprising a mixture of the first component and the second component.

FIG. 9 shows an example of producing a nanoparticle ink formulation using a system for producing the nanoparticle ink formulation.

A hexane solution containing nanoparticles is referred to as a first fluid source 902, an aqueous solution in which a dispersant is dissolved as an ink component is referred to as a second fluid source 903, and an aqueous solution in which a moisturizer is dissolved as an ink component is referred to as a third fluid source 904. The first fluid source, the second fluid source, and the third fluid source pass through the continuous flow path 901 to produce the nanoparticle ink formulation. The continuous flow path 901 may comprise one or more flow tubes. In addition, a plurality of fluid sources may be used depending on the type of ink component added to the nanoparticle ink formulation, and the plurality of ink components may be combined into one ink component and used as one fluid source.

The hexane solution containing nanoparticles flows from the first fluid source 902 into the shear-flow reactor 905 via the first input system 908, and the aqueous solution in which a dispersant is dissolved as an ink component flows from the second fluid source 903 into the shear-flow reactor 905 via the second input system 909. Furthermore, the aqueous solution in which a moisturizer is dissolved as an ink component flows from the third fluid source 904 into the shear-flow reactor 905 via the first input system 910. The nanoparticles and each ink component are mixed in the shear-flow reactor. The resulting product stream is collected by the collect system 906. The product stream collected by the collect system 906 is sent to the analysis system 907 for analysis. Here, the collect system and the analysis system do not need to be continuous. In the analysis system, if the properties of the resulting nanoparticle ink formulation are not within the predetermined specifications, the product stream can be sent to the shear-flow reactor again. As this time, the flow rate and concentration of the input source flowing from the input system may be changed, and also the temperature and pressure in the shear-flow reactor, the rotation speed of the rotor, and the distance between the rotor and the stator may be changed.

A two-component mixed phase reaction also may be carried out using a continuous flow reaction to produce quantum dot inks. In this example, the first component and the second component of the previous example may be prepared and injected simultaneously into the shear-flow reactor as the shear-flow reactor is running using predetermined functional parameters, as described above. Post-reacted material may then be collected, comprising a mixture of the first component and the second component. The first component and the second component may be continuously fed into the shear-flow reactor at predetermined feed rates while maintaining an ongoing collection process.

In another example, a simple three-component mixed phase reaction system may be established to produce bi-metal nanoparticle ink formulations. A first component may be prepared containing a first metal nanoparticle in a supporting organic solvent, such as hexane or a mixture of hexanes. A second component may be prepared containing a second metal nanoparticle in a supporting organic solvent. A third component may be prepared containing a dispersant agent in an aqueous solvent. The first component, the second component and the third component may be injected simultaneously into the shear-flow reactor as the shear-flow reactor is running using predetermined functional parameters, as described above. Post-reacted material may then be collected, comprising a mixture of the first component, the second component and the third component. This example may also be carried out in a continuous-flow process, in which the first component, the second component, and the third component may be continuously fed into the shear-flow reactor at predetermined feed rates while maintaining an ongoing collection process.

In yet another example, a simple three-component mixed phase reaction system may be used to produce metal nanoparticle ink formulations, with in-situ metal nanoparticle synthesis. A first component may be prepared containing a metal precursor within a supporting organic solvent, such as hexanes. A second component may be prepared containing a reducing agent, such as oleyl amine. A third component may be prepared containing a dispersant agent. The first component, the second component and the third component may be injected simultaneously into the shear-flow reactor as the shear-flow reactor is running using predetermined functional parameters, as described above. Post-reacted material, comprising a mixture of the first component, the second component and the third component, and containing newly synthesized metal nanoparticle ink formulations dispersed in the mixture, may then be collected following processing. This example may also be carried out in a continuous-flow process, in which the components are continuously fed into the shear-flow reactor at predetermined feed rates while maintaining an ongoing collection process. While described in the context of two- and three-component systems, a shear mixing system according to the present disclosure may have any suitable number of component inputs, including more than three.

The method for producing nanoparticles and the nanoparticles according to the embodiment of the present invention adopt the following configurations.

(1) A method for producing nanoparticles with ligands bound to the surface of the nanoparticles, which comprises a step of mixing and processing a first solution and a second solution in a shear-flow reactor, and

the first solution contains a first solvent in which nanoparticles having a initial ligand bound to the surface of the nanoparticles are dissolved,

the second solution contains a second solvent in which the second ligand dissolved,

a ligand exchange reaction is carried out in the shear-flow reactor to form a solution of the nanoparticles in which the second ligand is bound to the surface of the nanoparticles.

(2) The method according to (1), wherein the second solvent is immiscible in the first solvent.

(3) The method according to (1) or (2), wherein the nanoparticles comprise quantum dots.

(4) The method according to any one of (1) to (3), wherein the nanoparticles comprise metal particles.

(5) The method according to any one of (1) to (4), wherein the initial ligand comprises a thiol group.

(6) The method according to any one of (1) to (5), wherein the shear-flow reactor is integrated into a continuous flow reactor.

(7) The method according to any one of (1) to (6), wherein the first solvent comprises one or more of 1-octadecene, toluene and hexane.

(8) The method according to any one of (1) to (7), wherein the second solvent comprises one or more of water, PGMEA and ethanol.

(9) A nanoparticle bound to a second ligand, formed by the method according to any one of claims (1) to (8).

The system for producing nanoparticles and the nanoparticles according to the embodiment of the present invention adopt the following configurations.

(10) A system for producing nanoparticles with ligands bound to the surface of the nanoparticles, which comprises a first input system, a second input system, a rotator, a stator and collect system, and the first input system configured to input a first solution, the first solution comprising the nanoparticle bound to an initial ligand and dissolved in a first solvent;
the second input system configured to input a second solution, the second solution comprising a second ligand dissolved in a second solvent;

the rotor and the stator are configured to process a mixture of the first solution and the second solution to carry out a ligand exchange reaction on the nanoparticles;

the collect system configured to output a product mixture comprising the nanoparticles bound to the second ligand and dissolved in the second solvent.

(11) The system according to (10), wherein the second solvent is immiscible in the first solvent.

(12) The s system according to (10) or (11), wherein the nanoparticles comprise quantum dots.

(13) The system according to any one of (10) to (12), wherein the nanoparticles comprise metal particles.

(14) The system according to any one of (10) to (13), wherein the rotor comprises two or more counter-rotating discs.

(15) The system according to any one of (10) to (14), wherein one or more of the first input system, the second input system and the collect system are integrated into a continuous flow reactor.

(16) The system according to any one of (10) to (15), wherein the second solvent comprises one or more of water, PGMEA and ethanol.

(17) A nanoparticle bound to a second ligand and dissolved in a second solvent, formed by the system according to any one of (10) to (16).

The method for producing nanoparticles and the nanoparticles according to the embodiment of the present invention adopt the following configurations.

(18) A method for producing nanoparticles, the method comprising: combining, in a shear-flow reactor, a first input and a second input, the first input comprising a solution of a group III element precursor compound dissolved in a solvent, and the second input comprising a gaseous phosphorus precursor compound; and processing the first input and the second input in the shear-flow reactor to form a solution of the nanoparticle.

(19) The method according to (18), wherein the first input further comprises an initial ligand dissolved in the solvent, the initial ligand comprising a thiol group.

(20) The method according to (18) or (19), wherein the group III element precursor comprises an indium precursor compound.

(21) The method according to any one of (18) to (20), wherein the solvent comprises one or more of 1-octadecene, toluene and hexane.

(22) The method according to any one of (18) to (21), wherein the gaseous phosphorus precursor compound comprises phosphine.

(23) A nanoparticle synthesized by the method according to any one of (18) to (22).

The method for producing nanoparticle ink formulation according to the embodiment of the present invention adopt the following configurations.

(24) A method for producing nanoparticle ink formulations, the method comprising:

combining, in a shear-flow reactor, a first solution and a second solution, the first solution comprising a nanoparticle in a first solvent, and the second solution comprising a second ink component dissolved in a second solvent; and processing the first solution and the second solution in the shear-flow reactor to form a product mixture comprising a mixed nanoparticle ink.

(25) The method according to (24), wherein the second solvent is immiscible with the first solvent.

### EXAMPLES

Hereinafter, the present invention will be described in more detail based on Examples and Comparative Examples, but the present invention is not limited thereto.

(Quantum Dot Synthesis)

Indium acetate (0.3 mmol) and zinc oleate (0.6 mmol) are added to a mixture of oleic acid (0.9 mmol), 1-dodecanthiol (0.1 mmol) and octadecene (10 mL), and heated to about 120° C. under vacuum (<20 Pa) and reacted for 1 hour. The mixture reacted under vacuum (<20 Pa) was placed in a nitrogen atmosphere at 25° C., tris (trimethylsilyl) phosphine (0.25 mmol) was added, and then heated to 300° C., reacted for 10 minutes, and cooled to 25° C. to obtain an InP core dispersion.

Then, 40 mmol of zinc oleate and 100 mL of octadecene were mixed and heated at 110° C. for 1 hour under vacuum to obtain a Zn precursor solution. Moreover, 22 mmol of selenium powder and 22 mmol of sulfur powder were mixed in 10 mL of trioctylphosphine and nitrogen, respectively, and stirred until all were dissolved to obtain trioctylphosphine selenide and trioctylphosphine sulfide.

The InP core dispersion is heated to 250° C. At 250° C., 4.5 mL of Zn precursor solution and 1.5 mL of trioctylphosphine selenide were added to the InP core dispersion, and the mixture was reacted for 30 minutes. Then, 4.0 mL of Zn precursor solution and 0.6 mL of trioctylphosphine sulfide were added to the mixture, and the mixture was heated to 280° C. and reacted for 1 hour to produce a quantum dot dispersion.

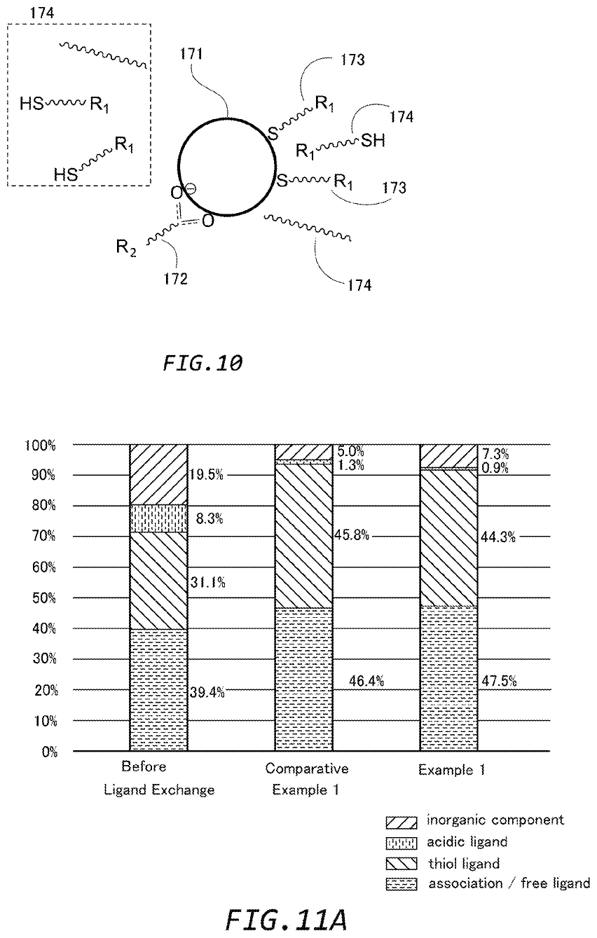

FIG. 10 shows an image diagram showing the states of the quantum dots and the ligand in the quantum dot dispersion liquid in this example. Inorganic component 171 mainly represents quantum dots. The acidic ligand 172 mainly represents a carboxylic acid ligand in this example. The thiol ligand 173, in this example, represents 1-dodecanehiol and ligand having a thiol group described later. The association/free ligand 174 represents a ligand that is not directly bound to the quantum dots in this example.

The quantum dot dispersion was centrifuged to remove the dispersion medium. The precipitate was subjected to thermogravimetric analysis (TGA) and weight loss and peak separation identified the type and amount of ligand coordinated to the quantum dots prior to ligand exchange.

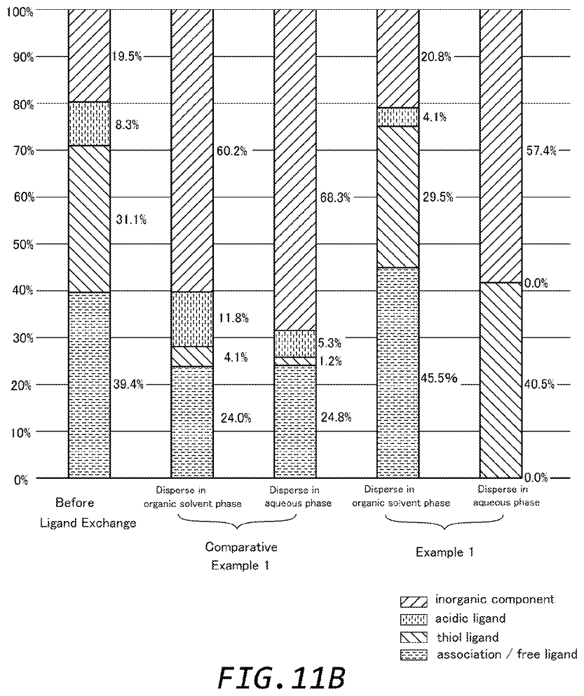

The proportion of various ligands coordinated to the quantum dots before the ligand exchange is shown in FIG. 11A. As shown in FIG. 11A, the quantum dots before the ligand exchange were 19.5% inorganic components, 8.3% acidic ligands, 31.1% thiol ligands, and 39.4% association/free ligands.

The amount of thiol ligand at this time is expressed below as the initial amount of thiol ligand.

Furthermore, based on the results of thermogravimetric analysis of the precipitate, octadecene was appropriately added to the precipitate to prepare a 1.0 mass % quantum dot/octadecene dispersion.

### (Comparative Example 1)—Ligand Exchange in Batch

To a 1.0 mass % quantum dot/octadecene dispersion, 6-mercapto-1-hexanol, which is 10 times the initial amount of thiol ligand, was added, the temperature was raised to 50° C., and the mixture was stirred with ultrasonic waves and reacted for 24 hours.

### (Example 1)—Ligand Exchange in the Shear-Flow Reactor

A 1.0 mass % quantum dot/octadecene dispersion was flowed through the first input system of the shear-flow reactor at a flow rate of 1 mL/min. Then, a hexane solution containing 6-mercapto-1-hexanol which is 10 times the initial amount of thiol ligand, was flowed through the second input system at a flow rate of 3 mL/min. The distance between the rotor and the stator in the shear-flow reactor was 400 μm, the treatment was performed at a rotation speed of 8000 rpm for 1 minute, and the obtained reaction product was collected in a collect system.

The reaction solutions obtained in Comparative Example 1 and Example 1 were centrifuged, and the obtained precipitate was subjected to thermogravimetric analysis (TGA) and weight loss and peak separation identified the type and amount of ligands coordinated to the quantum dots before and after ligand exchange.

FIG. 11A shows the proportion of various ligands coordinated to the quantum dots before the ligand exchange, and of ligands coordinated to the quantum dots prepared in Comparative Example 1 and Example 1, respectively. It should be noted here that the thiol ligands of Comparative Example 1 and Example 1 also include 6-mercapto-1-hexanol.

Comparing the results of Comparative Example 1 and Example 1, the quantum dots, one can find that acidic ligands, thiol ligands, and association/free ligands all show similar proportions. This shows that the ligand exchange, which takes 24 hours in the conventional batch processing as in Comparative Example 1, can be performed in a short time (1 minute in this case) by using shear-flow reactor as in Example 1.

The table below summarizes the results focusing on the proportions of the acidic ligand and the thiol ligand bound to the quantum dots of the quantum dot/octatadecene dispersion, Comparative Example 1 and Example 1.

TABLE 1

| | Oleic Acid | Thioleic Acid | Thiol |
|---|---|---|---|
| | Ligand | Ligand | Ligand |
| Quantum Dot Dispersion | 1 | 1 | 3.7 |
| Comparative Example 1 | 1 | 1 | 35.2 |
| Example 1 | 1 | 1 | 49.2 |

In both Comparative Example 1 and Example 1, the amount of thiol ligand bound to the quantum dots increased. It was shown that Example 1 in which the ligand was exchanged in the shear-flow reactor effectively removed the acidic ligand in a short time and promoted the thiol ligand binding.

### (Comparative Example 2)—Ligand Exchange in Batch

An aqueous solution of PEX (potassium ethylxanthate) was added to the quantum dot/octadecene dispersion, the temperature was raised to 50° C., and the mixture was stirred with ultrasonic waves and reacted for 24 hours.

### (Example 2)—Ligand Exchange in the Shear-Flow Reactor

A 1.0 mass % quantum dot/octadecene dispersion was flowed through the first input system of the shear-flow reactor at a flow rate of 1 mL/min, and then a PEX (potassium ethylxanthate) aqueous solution was flowed through the second input system at a flow rate of 1 mL/min. The distance between the rotor and the stator in the shear-flow reactor was 400 μm, the treatment was performed at a rotation speed of 8000 rpm for 1 minute, and the obtained reaction product was collected in a collect system.

The reaction solutions obtained Comparative Example 2 and Example 2 both separated into two phases of an aqueous phase and an organic solvent phase. Centrifugation was performed on the aqueous phase and organic solvent phase of the reaction solutions obtained in Comparative Example 2 and Example 2, and the precipitate was subjected to thermogravimetric analysis (TGA) to identify the type and amount of ligand coordinated to the quantum dots. FIG. 11B shows the proportion of the various ligands coordinated to the quantum dots before the ligand exchange, and of ligands coordinated to the quantum dots dispersed in the aqueous phase and organic solvent phase of Comparative Example 2 and Example 2, respectively.

The results of the organic solvent phase and the aqueous phase obtained in Comparative Example 2 reveals that there was no significant difference in the proportion of the ligands coordinated to the quantum dots. On the other hand, in Example 2, there was a difference in the ligands coordinated to the quantum dots dispersed in the organic solvent phase and the aqueous phase. The only ligand coordinated to the quantum dots dispersed in the aqueous phase is the thiol ligand, and it was shown that by the use of the shear-flow reactor exchange of ligands to PEX ligands that contributes to the dispersion in the aqueous phase took place effectively.

From this result, it was shown that ligand exchange using the shear-flow reactor is also effective in a two-phase process.

### Example 3

Indium acetate (4.8 mmol), zinc oleate (10.1 mmol), oleic acid (13 mmol), 1-dodecanethiol (1.4 mmol) and 1-octadecene (160 mL) were stirred while vacuuming in a flask with a vacuum pump. Then, the mixture was heated to 110° C. and reacted for 20 hours, and then cooled to 25° C. in a nitrogen gas atmosphere to obtain an In precursor. The obtained In precursor was flowed through a first input system of the shear-flow reactor at a flow rate of 1 mL/min. PH₃ gas was flowed through a second input system of the shear-flow reactor at a pressure of 1 mL/min. They were treated in a shear-flow reactor for 1 minute. The obtained treatment liquid was directly advanced to a heating stage of the continuous flow reactor and heated so that the treatment liquid was maintained at a temperature of 300° C. for 10 minutes to obtain InP nanoparticles.

It will be understood that the configurations and/or approaches described herein are presented for example, and that these specific examples or examples are not to be considered in a limiting sense, because numerous variations are possible. For example, in some implementations the reactants and processes described herein may be used in a batch reactor system, as opposed to a continuous flow system. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of this disclosure includes all novel and nonobvious combinations and subcombinations of the various processes, systems and configurations, and other features, functions, acts, and/or properties disclosed herein, as well as any and all equivalents thereof.

### REFERENCE CHARACTER LIST

100 shear-flow reactor
104 motor
108 rotor
112 stator
116 first input system
120 second input system
124 space
128 coupling
136 collect system
140 shear force
144 quantum dot
148 initial ligand
152 empty coordination site
156 second ligand
160 quantum dot
300 continuous flow reactor
310 continuous flow path
325 mixing and segmentation stage
335 reaction flow
340 thermal reactor
345 product flow
350 quality meter
351 controller
370 ligand exchange reactor
380 valve
400 example method for conducting ligand exchange reaction
500 system for producing nanoparticle
501 continuous flow path
502 first fluid source
503 second fluid source
504 shear-flow reactor
505 collect system
506 analysis system
507 first input system
508 second input system
600 example method for producing quantum dot
700 system for producing quantum dot
701 continuous flow path
702 first fluid source
703 second fluid source
704 shear-flow reactor
705 thermal reactor
706 collect system
707 analysis system
708 first input system
709 second input system
800 example method for producing nanoparticle ink
formulation
900 system for producing nanoparticle ink formulation
901 continuous flow path
902 first fluid source
903 second fluid source
904 third fluid source
905 shear-flow reactor
906 collect system
907 analysis system
908 first input system
909 second input system
910 third input system
171 inorganic component
172 acidic ligand
173 thiol ligand
174 association/free ligand

1. A method for producing nanoparticles with ligands bound to the surface of the nanoparticles, which comprises a step of mixing and processing a first solution and a second solution in a shear-flow reactor, and
the first solution contains a first solvent in which nanoparticles having a initial ligand bound to the surface of the nanoparticles are dissolved,
the second solution contains a second solvent in which the second ligand dissolved,
a ligand exchange reaction is carried out in the shear-flow reactor to form a solution of the nanoparticles in which the second ligand is bound to the surface of the nanoparticles.

2. The method according to claim 1, wherein the second solvent is immiscible in the first solvent.

3. The method according to claim 1, wherein the nanoparticles comprise quantum dots.

4. The method according to claim 1, wherein the nanoparticles comprise metal particles.

5. The method according to claim 1, wherein the initial ligand comprises a thiol group.

6. The method according to claim 1, wherein the shear-flow reactor is integrated into a continuous flow reactor.

7. The method according to claim 1, wherein the first solvent comprises one or more of 1-octadecene, toluene and hexane.

8. The method according to claim 1, wherein the second solvent comprises one or more of water, PGMEA and ethanol.

9. A nanoparticle bound to a second ligand, formed by the method according to claim 1.

10. A system for producing nanoparticles with ligands bound to the surface of the nanoparticles, which comprises a first input system, a second input system, a rotator, a stator and a collect system, and
the first input system configured to input a first solution, the first solution comprising the nanoparticle bound to an initial ligand and dissolved in a first solvent;
the second input system configured to input a second solution, the second solution comprising a second ligand dissolved in a second solvent;
the rotor and the stator are configured to process a mixture of the first solution and the second solution to carry out a ligand exchange reaction on the nanoparticles;
the collect system configured to output a product mixture comprising the nanoparticles bound to the second ligand and dissolved in the second solvent.

11. The system according to claim 10, wherein the second solvent is immiscible in the first solvent.

12. The s system according to claim 10, wherein the nanoparticles comprise quantum dots.

13. The system according to claim 10, wherein the nanoparticles comprise metal particles.

14. The system according to claim 10, wherein the rotor comprises two or more counter-rotating discs.

15. The system according to claim 10, wherein one or more of the first input system, the second input system and the collect system are integrated into a continuous flow reactor.

16. The system according to claim 10, wherein the second solvent comprises one or more of water, PGMEA and ethanol.

17. A nanoparticle bound to a second ligand and dissolved in a second solvent, formed by the system according to claim 10.

18.-23. (canceled)

24. A method for producing nanoparticle ink formulations, the method comprising:
combining, in a shear-flow reactor, a first solution and a second solution, the first solution comprising a nanoparticle in a first solvent, and the second solution comprising a second ink component dissolved in a second solvent; and
processing the first solution and the second solution in the shear-flow reactor to form a product mixture comprising a mixed nanoparticle ink.

25. The method according to claim 24, wherein the second solvent is immiscible with the first solvent.
